(19) United States
(12) Patent Application Publication
(10) Pub. No.: US 2026/0352384 A1
(43) Pub. Date: Nov. 5, 2026

(54) HARQ Process Prioritization Rules for Unlicensed Transmissions

(71) Applicant: Apple Inc., Cupertino, CA (US)

(72) Inventors: Ping-Heng KUO, London (GB); Naveen Kumar R PALLE VENKATA, San Diego, CA (US); Ralf ROSSBACH, Munich (DE)

(21) Appl. No.: 19/487,663

(22) PCT Filed: May 30, 2024
(86) PCT No.: PCT/US2024/031630

§ 371 Date: Nov. 25, 2025

Related U.S. Application Data
(60) Provisional application No. 63/504,874, filed on May 30, 2023.

(51) Int. Cl. H04L 1/1829; H04L 1/1812; H04W 72/231

(52) U.S. Cl. CPC H04L 1/1854; H04L 1/1812; H04L 1/1835; H04W 72/231

(57) ABSTRACT

An apparatus configured to decode, from signaling received from a network, a plurality of configured grant (CG) configurations, wherein each CG configuration comprises one or more CG Physical Uplink Shared Channel (PUSCH) occasions per CG period and a hybrid automatic repeat request (HARQ) prioritization rule, wherein a first HARQ process prioritization rule for a first CG configuration is different than a second HARQ process prioritization rule for a second CG configuration, process a first CG PUSCH occasion of o the first CG configuration, wherein the processing comprises selecting a first HARQ process identifier (PID) associated with a first data unit to be transmitted on the first CG occasion based on the first HARQ process prioritization rule and generate, for transmission to the network, the first data unit associated with the first HARQ PID using the first CG PUSCH occasion.

### PRIORITY/INCORPORATION BY REFERENCE

This application claims priority to U.S. Provisional Application Ser. No. 63/504,874 filed on May 30, 2023 and entitled, “HARQ Process Prioritization Rules for Unlicensed Transmissions,” the entirety of which is incorporated by reference herein.

### BACKGROUND

A Fifth Generation (5G) new radio (NR) network may support extended reality (XR) services. Due to the periodic nature of XR traffic, configured grants (CGs) may be used by the network for resource allocation. The transmissions performed by a user equipment (UE) in the uplink (UL) may use the CGs to send various data to the network. These transmissions may occur in the unlicensed spectrum (e.g., NR-U). Each of the transmissions may be associated with a Hybrid Automatic Repeat Request (HARQ) process. There may be rules associated with applying the HARQ process to the different transmissions.

### SUMMARY

Some example embodiments are related to an apparatus having processing circuitry configured to decode, from signaling received from a network, a plurality of configured grant (CG) configurations, wherein each CG configuration comprises one or more CG Physical Uplink Shared Channel (PUSCH) occasions per CG period and a hybrid automatic repeat request (HARQ) prioritization rule, wherein a first HARQ process prioritization rule for a first CG configuration is different than a second HARQ process prioritization rule for a second CG configuration, process a first CG PUSCH occasion of the first CG configuration, wherein the processing comprises selecting a first HARQ process identifier (PID) associated with a first data unit to be transmitted on the first CG occasion based on the first HARQ process prioritization rule and generate, for transmission to the network, the first data unit associated with the first HARQ PID using the first CG PUSCH occasion.

Other example embodiments are related to an apparatus having processing circuitry configured to decode, from signaling received from a network, a configured grant (CG) configuration and two or more hybrid automatic repeat request (HARQ) prioritization rules, process a first CG Physical Uplink Shared Channel (PUSCH) occasion, wherein the processing comprises selecting a first HARQ process identifier (PID) associated with a first data unit to be transmitted in the first CG PUSCH occasion based on a first one of the two or more HARQ process prioritization rules and generate, for transmission to the network, the first data unit associated with the first HARQ PID using the first CG PUSCH occasion.

Still further example embodiments are related to an apparatus having processing circuitry configured to decode, from signaling received from a network, a plurality of configured grant (CG) configurations, wherein each CG configuration comprises one or more CG Physical Uplink Shared Channel (PUSCH) occasions per CG period, determine a hybrid automatic repeat request (HARQ) prioritization rule that is to be applied to each of the CG configurations based on at least a characteristic of each of the CG configurations, process a first CG PUSCH occasion of a first CG configuration, wherein the processing comprises selecting a first HARQ process identifier (PID) associated with a first data unit to be transmitted on the first CG occasion based on the determined HARQ process prioritization rule and generate, for transmission to the network, the first data unit associated with the first HARQ PID using the first CG PUSCH occasion.

Additional example embodiments are related to an apparatus having processing circuitry configured to decode, from signaling received from a network, a configured grant (CG) configuration, wherein each CG configuration comprises one or more CG Physical Uplink Shared Channel (PUSCH) occasions per CG period and a hybrid automatic repeat request (HARQ) prioritization rule, wherein the HARQ process prioritization rule is based on data availability in buffers of one or more identified logical channels (LCHs), process a first CG PUSCH occasion of the CG configuration, wherein the processing comprises selecting a first HARQ process identifier (PID) associated with a first data unit to be transmitted on the first CG occasion based on the HARQ process prioritization rule and generate, for transmission to the network, the first data unit associated with the first HARQ PID using the first CG PUSCH occasion.

More example embodiments are related to an apparatus having processing circuitry configured to decode, from signaling received from a network, a configured grant (CG) configuration, wherein each CG configuration comprises one or more CG Physical Uplink Shared Channel (PUSCH) occasions per CG period and a hybrid automatic repeat request (HARQ) prioritization rule, wherein the HARQ process prioritization rule is based on data delay information for the UE, process a first CG PUSCH occasion of the CG configuration, wherein the processing comprises selecting a first HARQ process identifier (PID) associated with a first data unit to be transmitted on the first CG occasion based on the HARQ process prioritization rule and generate, for transmission to the network, the first data unit associated with the first HARQ PID using the first CG PUSCH occasion.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4A shows a first example CG configuration comprising a single CG PUSCH occasion in a CG period according to various example embodiments.

FIG. 4B shows a second example CG configuration comprising multiple CG PUSCH occasions in a CG period according to various example embodiments.

FIG. 5 shows a UE configuration comprising two CG configurations according to various example embodiments.

FIG. 6 shows an example method of a UE applying HARQ process prioritization rules per CG configuration according to various example embodiments.

FIG. 7 shows a UE configuration comprising multiple CG PUSCH occasions in a CG period according to various example embodiments.

FIG. 8 shows an example method of applying a HARQ process prioritization rule based on data availability of specific logical channels (LCHs) according to various example embodiments.

FIG. 9 shows an example method of applying HARQ process prioritization rule(s) based on a buffer delay according to various example embodiments.

### DETAILED DESCRIPTION

The example embodiments may be further understood with reference to the following description and the related appended drawings, wherein like elements are provided with the same reference numerals. The example embodiments are related to applying Hybrid Automatic Repeat Request (HARQ) process rules (e.g., prioritization or selection rules) on a per configured grant (CG) configuration. In addition, multiple HARQ process prioritization or selection rules may be applied within a single CG configuration. Moreover, examples of new HARQ process prioritization or selection rules are also described.

The example embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a 5G NR network that supports extended Reality (XR). XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). While the example embodiments are described with reference to XR, the example embodiments may be applied to multiple configured grant (CG) Physical Uplink Shared Channel (PUSCH) transmission mechanisms. That is, the example embodiments are not limited to scenarios where the UE is engaged in XR operations. In addition, the example embodiments are not limited to being implemented in 5G networks. The example embodiments may be implemented in other types of cellular networks (e.g., legacy networks such as LTE or future evolutions of the cellular network such as 6G networks) or non-cellular networks (e.g., WiFi networks).

XR services may utilize multiple data flows in the uplink and/or downlink. Some examples include video streams, audio streams, pose streams, data streams, control streams, etc. From a physical channel perspective, there may be different control channels and shared channels for each stream or multiple streams may share a control channel and/or shared channel. In some configurations, each stream may have different quality of service (QoS) requirements (e.g., block error rate (BLER), latency requirements, etc.) and channel characteristics (e.g., packet arrival periodicity, burst arrival time, jitter etc.).

For XR, data payload is typically periodic. For example, a video frame rate may be 60, 90 or 120 frames per second. The radio access network may obtain assistance information (e.g., from either the UE or the core network) related to the characteristics of the XR traffic and utilize the assistance information to perform resource allocation for the XR services. Due to the periodic nature of XR traffic, a CG resource allocation method may be used by the network for resource allocation. A CG may be considered to be a pre-configured periodic UL radio resource that allows the UE to know in advance where (e.g., in the time-frequency resource grid) the PUSCH resources are available for UL, without the need for dynamic signaling of resource allocation.

Throughout this description, when referring to data that is being transmitted using a CG, this data may be referred to as a data unit. In some examples, the data unit may be data associated with a Medium Access Control (MAC) Protocol Data Unit (PDU). However, the data is not limited to MAC PDUs, the example embodiments may be implemented when other types of data units are to be transmitted.

As described above, there are different types of XR traffic (e.g., video, audio, pose, etc.). The network may obtain assistance information relating to characteristics of the different types of XR traffic, and utilize this information to perform appropriate resource allocation for XR services, e.g., the periodicity and size of CGs may be configured based on the characteristics of the XR traffic. In addition, the XR traffic may have performance characteristics such as a quasi-periodic packet arrival rate due to random jitter and a packet size that may vary over time. In some scenarios, to account for these performance characteristics, the network may configure multiple CG PUSCH transmission occasions in a period of a single CG configuration, e.g., multi-CG PUSCH configurations.

As also stated above, the PUSCH transmissions based on the CGs may use the unlicensed spectrum (e.g., NR-U). When performing such transmissions, the UE may be configured with a CG Retransmission Timer (CGRT) that can be configured to enable autonomous retransmission. For example, each PUSCH transmission may be associated with a HARQ process identifier (PID). When CGRT is configured, the UE can select the HARQ PID of each CG PUSCH by itself. A CGRT associated with a HARQ PID starts with the PUSCH transmission corresponding to the HARQ process. When the CGRT expires, if the UE does not receive any feedback in the DL that acknowledges successful reception of the transport block (TB) transmitted in the UL, the UE can use a subsequent CG resource to perform autonomous retransmission of the stored TB, e.g., the UE can select the HARQ process of the subsequent CG resource to be the one corresponding to the TB stored in the HARQ buffer. In one example, the UE may prioritize HARQ processes corresponding to retransmissions over HARQ processes corresponding to initial transmissions. In another example, logical channel (LCH) priority based HARQ process selection may be configured in the MAC entity. In some examples, such retransmissions may be an inefficient use of the CGs for a particular data stream.

The example embodiments introduce manners of configuring a UE with HARQ process rules (e.g., prioritization or selection rules) on a per CG configuration, e.g., a UE with multiple simultaneous CG configurations may apply different HARQ process prioritization or selection rules for these different CG configurations. In addition, for multi-PUSCH CG configurations, multiple HARQ process prioritization or selection rules may be applied within a single CG configuration. Techniques for dynamically switching these HARQ process prioritization or selection rules within a single CG configuration are also described. The example embodiments also describe examples of new HARQ process prioritization or selection rules that may be more efficient for delivering data in the uplink for certain types of traffic streams.

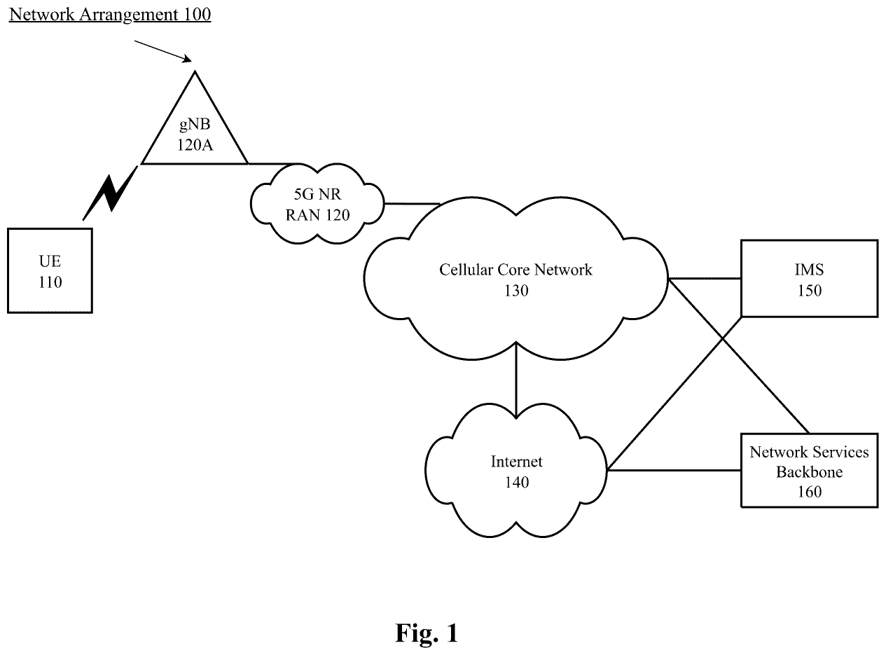

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the example embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

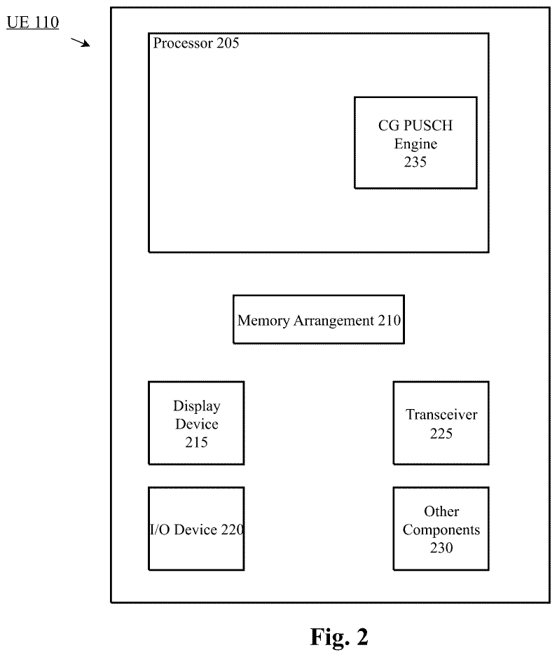

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a CG PUSCH engine 235. The CG PUSCH engine 235 may perform a variety of operations related to applying HARQ process prioritization or selection rules for CG configurations. The operations may include, but are not limited to, applying different HARQ process prioritization or selection rules for different CG configurations, applying different HARQ process prioritization or selection rules for multi-PUSCH CG configurations, etc. These example operations will be described in greater detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

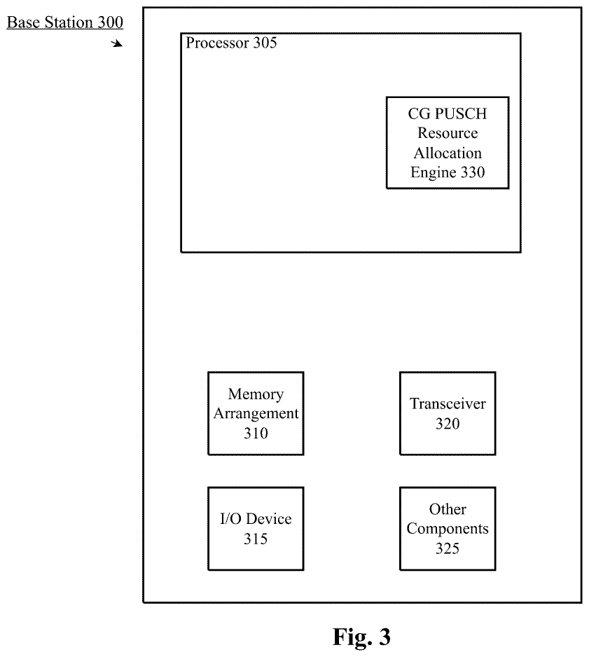

FIG. 3 shows an example base station 300 according to various example embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a CG PUSCH resource allocation engine 330. The CG PUSCH resource allocation engine 330 may perform a variety of operations for configuring CG PUSCH and related HARQ process prioritization or selection rules. The operations may include, but are not limited to, configuring CG PUSCH based on assistance information, configuring different HARQ process prioritization or selection rules for different CG configurations, configuring different HARQ process prioritization or selection rules for multi-PUSCH CG configurations, etc. These example operations will be described in greater detail below.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The example embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

As mentioned above, some example embodiments relate to cases where XR services operate in NR-U, multiple CGs are configured to support different types of UL periodic traffic flows (e.g., video, audio, pose information, etc.), and the UE can select a HARQ process for each CG-PUSCH as a CGRT is configured. While the example embodiments are described with reference to these aspects of XR traffic, the example techniques introduced herein are not limited to these characteristics of XR traffic or even to scenarios where the UE 110 is engaged in XR operations.

Prior to discussing the example techniques introduced herein, some example CG configurations will be described. In the example embodiments, it may be considered that the UE 110 is configured with the CG configurations by the network (e.g., the gNB 120A). The CG configuration may be signaled to the UE via Radio Resource Control (RRC) signaling, e.g., in the Information Element (IE) ConfiguredGrantConfig. The CG configuration may be signaled to the UE using other signaling methods, e.g., Medium Access Control Control Element (MAC CE), Downlink Control Information (DCI), etc.

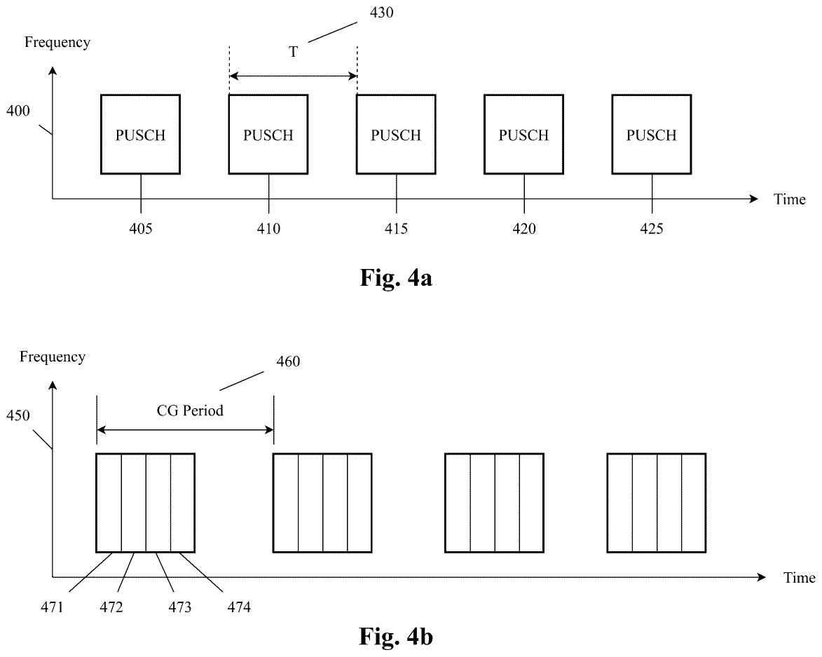

FIG. 4A shows a first example CG configuration 400 comprising a single CG PUSCH occasion in a CG period according to various example embodiments. The example of FIG. 4A shows CG PUSCH occasions 405-425. Each CG PUSCH occasion 405-425 is a single CG PUSCH occasion in a CG period. For example, FIG. 4A shows a CG period 430 that includes the single CG PUSCH occasion 410.

FIG. 4B shows a second example CG configuration 450 comprising multiple CG PUSCH occasions in a CG period according to various example embodiments. For example, the CG configuration 450 has a CG period 460 that has four (4) CG PUSCH occasions 471-474. This type of CG configuration is typically used for traffic with varying packet sizes, such as audio and/or video. However, the network may configure any type of traffic using this example CG configuration.

The above CG configurations are only examples and other CG configurations may also be used by the network, e.g., multiple CG PUSCH occasion configuration with more or less than 4 CG PUSCH occasions. In addition, as will be described in greater detail below, the network may simultaneously configure multiple CG configurations for a UE.

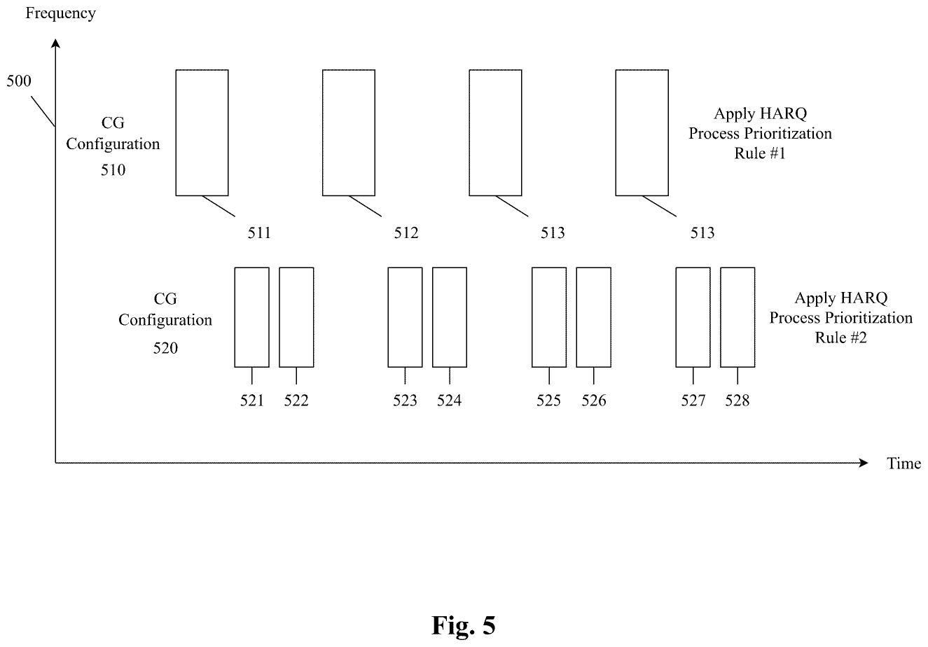

FIG. 5 shows a UE configuration 500 comprising two CG configurations 510 and 520 according to various example embodiments. The example of FIG. 5 is used to illustrate the network configuring HARQ process prioritization or selection rules per CG configuration. In this example, the network (e.g., gNB 120A) has simultaneously configured the UE 110 with multiple CG configurations, e.g., CG configuration 510 and CG configuration 520. In this example, the CG configuration 510 comprises CG PUSCH occasions 511-514 which are single CG PUSCH occasion per CG period (e.g., similar to the CG configuration of FIG. 4A) and the CG configuration 520 comprises CG PUSCH occasions 521-528 which are multi-PUSCH CG occasions per CG period (e.g., similar to the CG configuration of FIG. 4B, except there are only two (2) CG PUSCH occasions per CG period). Each CG configuration 510 and 520 may be per bandwidth part (BWP).

For each of the CG configurations 510 and 520, the gNB 120A may further indicate the intended HARQ process prioritization rule(s) that the UE should apply when processing a CG resource of the respective CG configuration. Some example HARQ process prioritization rules will be described in greater detail below. However, for the purposes of this example, the particular rule that is applied to each CG configuration 510 and 520 is not important. Rather, this example shows that simultaneous CG configurations may apply different HARQ process prioritization rules, e.g., the UE 110 applies HARQ process prioritization rule #1 for the CG configuration 510 and applies HARQ process prioritization rule #2 for the CG configuration 520. Similar to the CG configuration, the HARQ process prioritization rules for each CG configuration may be signaled to the UE 110 via RRC in the IE ConfiguredGrantConfig or any other signaling used for the CG configuration.

In some example embodiments, the UE 110 may be preconfigured with HARQ process prioritization or selection rules including characteristics as to when particular HARQ process prioritization or selection rules should be applied. In these examples, the UE 110 may determine the HARQ process prioritization or selection rule for a CG configuration based on the characteristics or other parameterizations of the CG configuration, such as the modulation/coding scheme (MCS), Physical Layer (PHY)-priority level, whether one or more Discontinuous Reception (DRX)-timer is disabled (e.g., drx-HARQ-RTT-TimerUL, drx-RetransmissionTimerUL, etc.), the number of CG PUSCH occasions in each CG period and/or the LCHs that are allowed to use this CG configuration. For example, the UE 110 may apply HARQ process prioritization rule #1 for the CG configuration 510 which has only one CG PUSCH per CG period, and may apply HARQ process prioritization rule #2 for the CG configuration 520 which has multiple CG PUSCH per CG period. In these examples, the HARQ process prioritization rule for each CG configuration is implied by the number of CG PUSCHs per CG period, and therefore additional signaling may not be needed.

In another example, the UE 110 applies HARQ process prioritization rule #1 for the CG configuration 510 as CG configuration 510 is only allowed to be used by LCH #1, and applies HARQ process prioritization rule #2 for the CG configuration 520 as CG configuration 520 is only allowed to be used by LCH #2. In another example, if the drx-HARQ-RTT-TimerUL and/or drx-RetransmissionTimerUL is disabled for a CG configuration 510 (e.g., the UE does not start drx-HARQ-RTT-TimerUL with the PUSCH of this CG), the UE may apply HARQ prioritization rule #1 (e.g., prioritize new transmission) for the CG configuration 510. In another example, if the drx-HARQ-RTT-TimerUL and/or drx-RetransmissionTimerUL is not disabled for a CG configuration 510 (e.g., the UE starts drx-HARQ-RTT-TimerUL with the PUSCH of this CG), the UE may apply HARQ prioritization rule #2 (e.g., prioritize retransmission) for the CG configuration 510.

The gNB 120A may also instruct the UE 110 to dynamically switch a HARQ process prioritization rule for each CG configuration. For example, the gNB 120A may initially configure the UE 110 with the CG configuration 510 comprising a HARQ process prioritization rule #1 and the CG configuration 520 comprising a HARQ process prioritization rule #2 (as shown in FIG. 5). Later, the gNB 120A may dynamically reconfigure or instruct the CG configuration 510 to comprise a HARQ process prioritization rule #3, e.g., using an update message sent via RRC, a MAC CE, or a DCI signaling. Later, the UE 110 may apply HARQ process prioritization rule #3 for CG PUSCH of configuration 510 and HARQ process prioritization rule #2 for CG PUSCH of configuration 520.

The number of simultaneous CG configurations is only an example, e.g., the network may configure the UE 110 with more than two (2) CG configurations. In addition, the use of one CG configuration with a single CG PUSCH occasion per CG period and one CG configuration with multiple CG PUSCH occasions per CG period is also an example. It is possible that both CG configurations are single CG PUSCH occasion per CG period configurations or both CG configurations are multi-PUSCH CG configurations (with the same or different numbers of CG PUSCH occasions per CG period). In addition, there is no significance to the relative frequency or timing of the CG configurations 510 and 520, e.g., the different frequencies are merely shown to indicate that the CG configurations are for different BWPs.

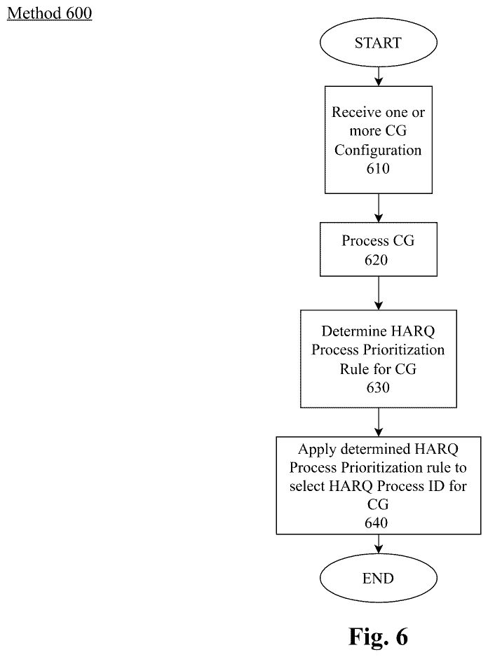

FIG. 6 shows an example method 600 of a UE applying HARQ process prioritization rules per CG configuration according to various example embodiments. The method 600 will be described with reference to the CG configurations illustrated in FIG. 5. However, the method 600 may be implemented for any one or more CG configurations. Such association may be implemented based on LCH mapping restriction of, for example, an Allowed CG List that can be configured for each LCH to indicate whether a CG configuration can be used by the LCH.

In 610, the UE 110 receives one or more CG configurations from the gNB 120A. As described above, the CG configuration may include the configuration of the CG PUSCH occasions and related information such as CG PUSCH resources (time and frequency), grant size, periodicity, etc. As also described above, the network may select the CG configuration to optimize the type of traffic that is being transmitted using the CGs of the CG configuration, e.g., based on assistance information. For example, the CG configuration 510 may be associated with pose traffic and the CG configuration 520 may be associated with audio/video traffic.

The CG configuration may also include a HARQ process prioritization rule for each of the CG configurations. To carry through with the example of FIG. 5, gNB 120A may configure the UE 110 with the CG configuration 510 comprising HARQ process prioritization rule #1 and the CG configuration 520 comprising HARQ process prioritization rule #2.

In 620, the UE 110 may process a configured grant. For example, the UE 110 may be processing the CG PUSCH occasion 512 of the CG configuration 510. In 630, the UE 110 determines the HARQ process prioritization rule to be applied for this CG occasion. In this example, it would be the HARQ process prioritization rule #1 because the CG PUSCH occasion 512 is associated with the CG configuration 510. To provide an example rule, the HARQ process prioritization rule #1 may be that the UE 110 should prioritize a HARQ PID based on the highest logical channel (LCH) priority. Again, this HARQ process prioritization rule is only an example and any other rule, for example, the other example rules described herein may be used as the HARQ process prioritization rule #1.

As described above, in this example, the CG configuration 510 may be associated with pose traffic. The pose traffic may be split among one or more LCHs. The TBs of the pose traffic may each be assigned a HARQ PID (e.g., when a TB is selected for transmission in a CG PUSCH, the TB is assigned a HARQ PID). Thus, in 640, the UE 110 selects a TB based on the determined HARQ process prioritization rule for transmission in the CG PUSCH occasion 512 and the selected TB is assigned a HARQ PID. For example, the UE 110 applying the example HARQ process prioritization rule #1 will select a TB from an LCH associated with pose traffic that has a highest priority for the HARQ PID.

To provide another example, in 620, the UE 110 may be processing the CG PUSCH occasion 523 of the CG configuration 520. The HARQ process prioritization rule #2 associated with the CG configuration 520 may be that the UE 110 should always prioritize retransmissions when selecting a HARQ PID. Thus, in 640, when applying this HARQ process prioritization rule, the UE 110 would select a TB that is to be retransmitted for the HARQ PID. Again, since the CG configuration 520 is associated with the audio/video traffic, the UE 110 would select an audio/video TB for retransmission.

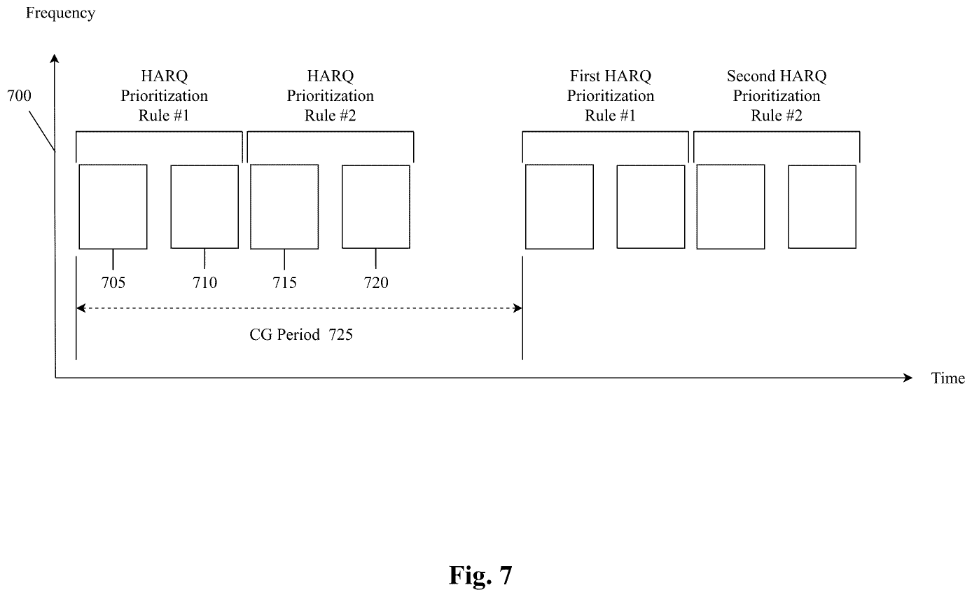

FIG. 7 shows a UE configuration 700 comprising multiple CG PUSCH occasions in a CG period according to various example embodiments. The CG configuration 700 of FIG. 7 may include aspects similar to the example CG configuration 450 of FIG. 4B. The CG configuration 700 comprises four (4) CG PUSCH occasions per CG period, e.g., CG PUSCH occasions 705-720 for CG period 725.

The example of FIG. 7 is used to illustrate the network configuring HARQ process rule (e.g., prioritization or selection rule) switching for multi-PUSCH CGs. Similar to the above examples, the network (e.g., gNB 120A) may configure the UE 110 with the CG configuration 700 that may include the CG PUSCH occasions with related information such as CG PUSCH resources (time and frequency), grant size, periodicity, etc. and the HARQ process prioritization rule(s). However, as shown in this example, CG configuration 700 may include two or more separate HARQ process prioritization rules for the multi-PUSCH CG occasions. In this example, the CG PUSCH occasions 705 and 710 are associated with the HARQ process prioritization rule #1 and the CG PUSCH occasions 715 and 720 are associated with the HARQ process prioritization rule #2. Thus, in this example, the UE 110 may apply different HARQ process prioritization rules within the same CG period for different CG PUSCH occasions.

To provide an example, the HARQ process prioritization rule #1 may be that a new transmission is always prioritized. Thus, in the CG PUSCH occasions 705 and 710 of the CG period 725, the UE 110 would prioritize new transmissions. The HARQ process prioritization rule #2 may be that retransmissions are always prioritized. Thus, in the CG PUSCH occasions 715 and 720 of the CG period 725, the UE 110 would prioritize retransmissions.

In some examples, the switching may be fixed (e.g., the multi-PUSCH CG configuration may be defined by standards such as th3 3GPP standards) or pre-configured (e.g., the gNB 120A may configure which HARQ process prioritization rule applies to which CG PUSCH occasion). In other examples, the UE 110 may determine to trigger switching based on the occurrence of certain events. For example, the UE 110 may switch the HARQ process prioritization rule when the buffer of specific LCH(s) become available or become empty. In other examples, the UE 110 may switch the HARQ process prioritization rule when an indication relating to activation/deactivation of a packet discarding mechanism (e.g., based on PDU Set importance) is received.

Again, the use of 4 CG PUSCH occasions is only an example, and the rule switching may be applied to multi-PUSCH CGs having any number of CG PUSCH occasions. In addition, the use of two HARQ process prioritization rules is also an example. Any number of HARQ process prioritization rules may be applied to multi-PUSCH CGs. For example, in FIG. 7, a different HARQ process prioritization rule may be applied to each CG PUSCH occasion, e.g., 4 HARQ process prioritization rules. In another example, a first HARQ process prioritization rule may be applied to the CG PUSCH occasion 705, a second HARQ process prioritization rule may be applied to the CG PUSCH occasion 710 and a third HARQ process prioritization rule may be applied to the CG PUSCH occasions 715 and 720. Other combinations of HARQ process prioritization rules and CG PUSCH may be derived based on the herein described principles.

In other example embodiments, the HARQ process prioritization rule switching may occur during different CG periods. For example, referring to FIG. 7, the HARQ process prioritization rule #1 may be applied to all the CG PUSCH occasions 705-720 in the CG period 725. After the CG period 725, the UE 110 may switch the HARQ process prioritization rule to the HARQ process prioritization rule #2, e.g., the HARQ process prioritization rule #2 is applied to all the CG PUSCH occasions in the subsequent CG period. In further CG periods, the UE 110 may switch back to the HARQ process prioritization rule #1 or may apply additional HARQ process prioritization rules. In these examples, the HARQ process prioritization rule switching may be applied to CG configurations having only a single CG PUSCH occasion per CG period.

In the above examples, some example HARQ process prioritization rules were described. The following provides some additional examples of HARQ process prioritization rules and UE methods for applying the example HARQ process prioritization rules. Any of the HARQ process prioritization rules described herein (e.g., the HARQ process prioritization rules previously described, and the HARQ process prioritization rules described below) may be used in the above examples. That is, any HARQ process prioritization rule described herein may be used as HARQ process prioritization rule #1 or #2 for the example of FIG. 5 or any HARQ process prioritization rule described herein may be used as HARQ process prioritization rule #1 or #2 for the example of FIG. 7.

A further example of a HARQ process prioritization rule may be related to the buffer availability of specific LCHs. For example, if data is available in the buffer of specific LCHs, the UE will prioritize new transmissions to include the data from the specific LCHs. As will be described by way of example below, this rule is different from an LCH priority rule. On the other hand, if data is not available in the buffer of the specific LCHs, the UE use other HARQ process prioritization rules, e.g., always prioritize retransmissions, prioritize based on logical channel priority, etc.

In some examples, the UE 110 may always prioritize new transmissions over retransmissions as long as there is data available in the buffer of any LCHs that are allowed to use this CG, the new transmission is prioritized.

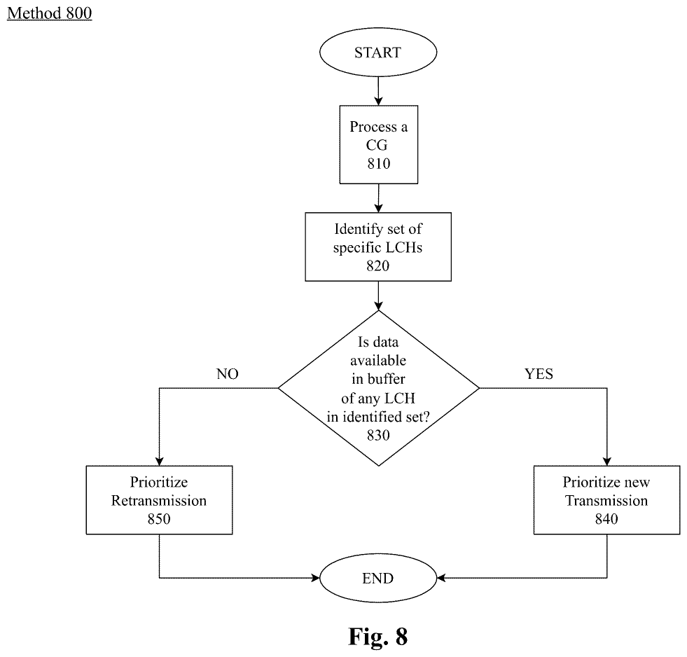

FIG. 8 shows an example method 800 of applying a HARQ process prioritization rule based on data availability of specific LCHs according to various example embodiments. In this example, it will be considered that the HARQ process prioritization rule based on data availability of specific LCHs is the rule described above. In addition, it will also be considered that the HARQ process prioritization rule is the HARQ process prioritization rule #2 of FIG. 5. This is only an example as the HARQ process prioritization rule may be the HARQ process prioritization rule #1 of FIG. 5 or the HARQ process prioritization rule #1 or #2 of FIG. 7.

Thus, prior to the start of the method 800, the UE 110 will receive a CG configuration from the gNB 120A, e.g., CG configuration 520 that comprises the example HARQ process prioritization rule based on data availability of specific LCHs. As described above, this CG configuration may be received via RRC signaling.

In 810, the UE 110 will process a CG PUSCH occasion of the CG configuration, e.g., CG PUSCH occasion 521 of CG configuration 520. In 820, the UE 110 will identify the set of specific LCHs for which the HARQ process prioritization rule applies, e.g., the specific LCHs for which the UE 110 will check the buffer. As described above, the gNB 120A may select the configuration for the CG configuration 520 based on characteristics of the traffic that is going to be transmitted using the CGs of the CG configuration 520. For example, the CG configuration 520 may have been configured for the purpose of transmitting video traffic. The gNB 120A may communicate this information to the UE 110 in the CG configuration 520. The information may be communicated as an identification of the type of traffic (e.g., video traffic) or as an identification of specific LCHs.

The UE 110 may use this information to identify the set of specific LCHs associated with the HARQ process prioritization rule. For example, if the information is communicated as an identification of the type of traffic (e.g., video traffic), the UE 110 will identify the LCHs associated with video traffic as the set of specific LCHs. If the information is communicated as an identification of specific LCHs, the UE 110 will identify these LCHs as the set of specific LCHS.

In 830, the UE 110 will check the buffers of the set of specific LCHs to determine if there is any data available in these buffers. As described above, the example HARQ process prioritization rule is that if data is available in the buffer of any of the specific LCHs, the UE 110 will prioritize new transmissions for this data. Thus, in 840, in the CG PUSCH occasion 521 the UE 110 will transmit a new transmission of data from one of the buffers of any of the specific LCHs that have data. As described above, this rule is separate from LCH priority. For example, a retransmission may have a higher LCH priority than the new transmission that is selected. However, that is allowed by this HARQ process prioritization rule. In another example, multiple ones of the set of specific LCHs may have new data in the buffer. The selected LCH for the new transmission may be based on LCH priority but may also be based on other criteria such as a round robin, first-in first-out (FIFO), etc.

On the other hand, if there is no data available in the buffer of any of the specific LCHs, in 850, the UE use a different HARQ process prioritization rule. For example, the UE 110 may prioritize retransmissions, if available. In another example, the UE 110 may prioritize LCHs based on LCH priority.

For Rel- 18 of the 3GPP standards, it has been agreed that UEs may provide “delay information” of buffered uplink data to the network for various reasons such as delay-aware scheduling. This delay information could be provided to network via a buffer status report (BSR) or other MAC CEs. Examples of the delay information may include an amount of time that data from one or more LCHs has been queueing/waiting in the buffer, an amount of remaining time until the delivery dead time of data buffered in one or more LCHs, whether data from one or more LCHs is considered as “urgent,” etc.

Since the UE 110 may already be collecting this information to report to the network, the UE 110 may also use the delay information for HARQ process prioritization.

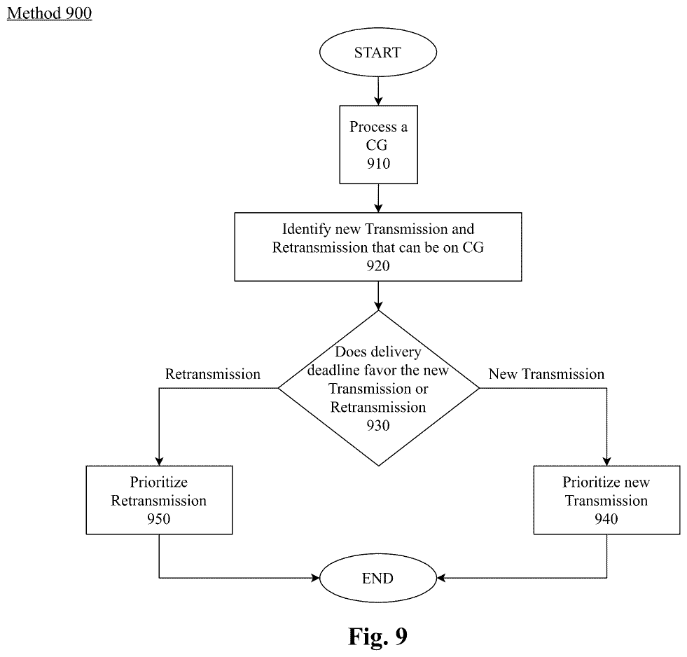

FIG. 9 shows an example method 900 of applying HARQ process prioritization rule(s) based on a buffer delay according to various example embodiments. Similar to the example of the method 800, the description of the method 900 will consider that the example HARQ process prioritization rule related to buffer delays is the HARQ process prioritization rule #2 of FIG. 5. Again, this is only an example as the HARQ process prioritization rule related to buffer delay may be used as a rule for any of the examples described herein.

Thus, prior to the start of the method 900, the UE 110 will receive a CG configuration from the gNB 120A, e.g., CG configuration 520 that comprises the example HARQ process prioritization rule based on buffer delays. As described above, this CG configuration may be received via RRC signaling.

In 910, the UE 110 will process a CG PUSCH occasion of the CG configuration, e.g., CG PUSCH occasion 521 of CG configuration 520. In 920, the UE 110 will identify a new transmission and a retransmission that may be transmitted using the CG PUSCH occasion being processed, e.g., CG PUSCH occasion 521 of CG configuration 520.

In 930, the UE 110 evaluates the identified new transmission and retransmission based on the HARQ process prioritization rule based on buffer delays. There may be various variations of the HARQ process prioritization rule based on buffer delays. In a first example, the UE 110 evaluates the remaining time to the delivery deadline for both data corresponding to the new transmission and the retransmission. The delivery deadline may be associated with the timing of expiry of a discard timer. The UE 110 selects the HARQ process associated with the data having a lower remaining time to the delivery deadline, e.g., the UE 110 prioritizes the new transmission in 940 when the new transmission has a lower remaining time to the delivery deadline or the UE 110 prioritizes the retransmission in 950 when the retransmission has a lower remaining time to the delivery deadline.

In a second example, the UE 110 may only evaluate the remaining time to the delivery deadline for data corresponding to the new transmission and selects the HARQ process associated with data corresponding to the new transmission if the remaining time is lower than a threshold, e.g., the new transmission is prioritized in 940. If the remaining time is greater than the threshold, retransmissions may be prioritized in 950. The threshold may be any time value and may be pre-configured (e.g., set by a standard such as a 3GPP standard) or signaled to the UE 110 as part of the CG configuration.

In a third example, the UE 110 may only evaluate the remaining time to the delivery deadline for data corresponding to the retransmission and selects the HARQ process associated with data corresponding to the retransmission if the remaining time is lower than a threshold, e.g., the retransmission is prioritized in 950. If the remaining time is greater than the threshold, new transmissions may be prioritized in 940. Again, the threshold may be any time value and may be pre-configured (e.g., set by a standard such as a 3GPP standard) or signaled to the UE 110 as part of the CG configuration.

In addition to (or exclusive of) the examples provided above, the UE 110 may further consider whether the evaluated remaining time to delivery deadline is associated with specific LCH(s) or Logical Channel Groups LCG(s), specific QoS Flow Identifier (QFI), specific Packet Data Unit (PDU) sessions, or specific type of PDU sets (e.g., important PDU Sets), etc.

A HARQ process may be associated with a MAC PDU comprising data from multiple LCHs (MAC Service Data Units (SDUs)). In these scenarios, the remaining time to the delivery deadline may be determined as the lowest, the highest, or the average remaining time to the deadline for the multiple LCHS multiplexed into a MAC PDU.

Furthermore, in the above examples, the remaining time to the delivery deadline was the “delay information” used by the UE 110 for HARQ prioritization. In other examples, other types of “delay information” may be used in the same manner as described above for the remaining time to the delivery deadline. Examples of these other types of “delay information” may include a “buffered time” that is how long the data has been queueing in the buffer, “the number of LCHs or MAC SDUs that are considered as urgent in new transmission MAC PDU and/or retransmission MAC PDU”, etc.

### EXAMPLES

In a first example, a method comprising decoding, from signaling received from a network, a plurality of configured grant (CG) configurations, wherein each CG configuration comprises one or more CG Physical Uplink Shared Channel (PUSCH) occasions per CG period and a hybrid automatic repeat request (HARQ) prioritization rule, wherein a first HARQ process prioritization rule for a first CG configuration is different than a second HARQ process prioritization rule for a second CG configuration, processing a first CG PUSCH occasion of the first CG configuration, wherein the processing comprises selecting a first HARQ process identifier (PID) associated with a first data unit to be transmitted on the first CG occasion based on the first HARQ process prioritization rule and configuring transceiver circuitry to transmit the first data unit associated with the first HARQ PID using the first CG PUSCH occasion.

In a second example, the method of the first example, further comprising processing a second CG PUSCH occasion of the second CG configuration, wherein the processing comprises selecting a second HARQ PID associated with a second data unit to be transmitted on the second CG occasion based on the second HARQ process prioritization rule and configuring transceiver circuitry to transmit the second data associated with the second HARQ PID using the second CG PUSCH occasion.

In a third example, the method of the first example, wherein the plurality of CG configurations is received from Radio Resource Control (RRC) signaling.

In a fourth example, the method of the first example, further comprising decoding, from signaling received from the network, an update for the first CG configuration, wherein the update comprises a third HARQ process prioritization rule for the first CG configuration that is different from the first HARQ process prioritization rule, wherein the third HARQ process prioritization rule is to be applied when processing CG PUSCH occasions of the first CG configuration occurring after the update is received.

In a fifth example, the method of the first example, wherein the first CG configuration comprises multiple CG PUSCH occasions per CG period and wherein the first HARQ process prioritization rule comprises a plurality of HARQ process prioritization rules, wherein a first one of the plurality of HARQ process prioritization rules applies to a first subset of the multiple CG PUSCH occasions and a second one of the plurality of HARQ process prioritization rules applies to a second subset of the multiple CG PUSCH occasions.

In a sixth example, the method of the first example, wherein the HARQ process prioritization rule comprises prioritizing retransmissions or prioritizing Medium Access Control (MAC) Protocol Data Units (PDU) based on LCH priority.

In a seventh example, the method of the first example, wherein the HARQ process prioritization rule is based on data availability in buffers of one or more identified LCHs.

In an eighth example, the method of the seventh example, wherein, when data is available in a buffer of at least one of the identified LCHs, the processing circuitry is configured to prioritize a new transmission that includes the data from the buffer of the at least one of the identified LCHs.

In a ninth example, the method of the seventh example, wherein, when data is not available in a buffer of at least one of the identified LCHs, the processing circuitry is configured to prioritize retransmissions or Medium Access Control (MAC) Protocol Data Units (PDU) based on LCH priority.

In a tenth example, the method of the seventh example, wherein the processing circuitry is configured to prioritize new transmissions over retransmissions when data is available in a buffer of any LCHs that are allowed to use a CG PUSCH occasion of a CG configuration.

In an eleventh example, the method of the first example, wherein the HARQ process prioritization rule is based on data delay information for the UE.

In a twelfth example, the method of the eleventh example, wherein, in response to the prioritization rule, the method further comprises determining a first remaining time to a delivery deadline for data associated with a new transmission and a second remaining time to a delivery deadline for data associated with a retransmission and prioritizing data associated with the lesser of the first remaining time or the second remaining time.

In a thirteenth example, the method of the twelfth example, wherein the data associated with the new transmission is associated with a Medium Access Control (MAC) Protocol Data Unit (PDU) comprising data from multiple LCHs, wherein the first remaining time is to be determined as a lowest remaining time for the multiple LCHs, a highest remaining time for the multiple LCHs, or an average remaining for the multiple LCHs.

In a fourteenth example, the method of the eleventh example, wherein, in response to the prioritization rule, the method further comprises comparing a remaining time to a delivery deadline for data associated with a new transmission to a threshold and prioritizing the new transmission when the remaining time satisfies the threshold, otherwise prioritize a retransmission.

In a fifteenth example, the method of the eleventh example, wherein, in response to the prioritization rule, the method further comprises comparing a remaining time to a delivery deadline for data associated with a retransmission to a threshold and prioritizing the retransmission when the remaining time satisfies the threshold, otherwise prioritize a new transmission.

In a sixteenth example, the method of the eleventh example, wherein the data delay information is associated to an identified LCH, an identified logical channel group (LC), an identified Quality of Service Flow Indicator (QFI), an identified Protocol Data Unit (PDU) session, or an identified type of PDU set.

In a seventeenth example, the method of the eleventh example, wherein the data delay information comprises a buffered time indicating how long data has been queueing in a buffer or a number of LCHs or MAC Service Data Units (SDUs) that are considered as urgent for a new transmission MAC PDU or a retransmission MAC PDU.

In an eighteenth example, a processor configured to perform any of the methods of the first through seventeenth examples.

In a nineteenth example, a user equipment (UE) comprising a transceiver configured to communicate with a network and a processor communicatively coupled to the transceiver and configured to perform any of the methods of the first through seventeenth examples.

In a twentieth example, a method comprising decoding, from signaling received from a network, a configured grant (CG) configuration and two or more hybrid automatic repeat request (HARQ) prioritization rules, processing a first CG Physical Uplink Shared Channel (PUSCH) occasion, wherein the processing comprises selecting a first HARQ process identifier (PID) associated with a first data unit to be transmitted in the first CG PUSCH occasion based on a first one of the two or more HARQ process prioritization rules and configuring transceiver circuitry to transmit the first data unit associated with the first HARQ PID using the first CG PUSCH occasion.

In a twenty first example, the method of the twentieth example, further comprising switching from the first one of the two or more HARQ process prioritization rules to a second one of the two or more HARQ process prioritization rules, processing a second CG PUSCH occasion, wherein the processing comprises selecting a second HARQ PID associated with a second data unit to be transmitted in the second CG PUSCH occasion based on the second one of the two or more HARQ process prioritization rules and configuring transceiver circuitry to transmit the second data unit associated with the second HARQ PID using the second CG PUSCH occasion.

In a twenty second example, the method of the twenty first example, wherein the first CG occasion and the second CG occasion are in a same CG period.

In a twenty third example, the method of the twenty first example, wherein the first CG occasion is in a first CG period and the second CG occasion is in a second CG period.

In a twenty fourth example, the method of the twenty first example, wherein the CG configuration comprises multiple CG PUSCH occasions per CG period or a single CG PUSCH occasion per CG period.

In a twenty fifth example, the method of the twenty first example, wherein the switch is based on one of a fixed switching pattern or based on switching information provided by the network in the CG configuration.

In a twenty sixth example, the method of the twenty first example, wherein the switch is triggered based on an occurrence of a predetermined event.

In a twenty seventh example, the method of the twenty sixth example, wherein the predetermined event comprises data becomes available in a buffer of an identified LCH, a buffer of an identified LCH is empty or an indication relating to activation/deactivation of a packet discarding mechanism.

In a twenty eighth example, a processor configured to perform any of the methods of the twentieth through twenty seventh examples.

In a twenty ninth example, a user equipment (UE) comprising a transceiver configured to communicate with a network and a processor communicatively coupled to the transceiver and configured to perform any of the methods of the twentieth through twenty seventh examples.

In a thirtieth example, a method comprising decoding, from signaling received from a network, a plurality of configured grant (CG) configurations, wherein each CG configuration comprises one or more CG Physical Uplink Shared Channel (PUSCH) occasions per CG period, determining a hybrid automatic repeat request (HARQ) prioritization rule that is to be applied to each of the CG configurations based on at least a characteristic of each e of the CG configurations, processing a first CG PUSCH occasion of a first CG configuration, wherein the processing comprises selecting a first HARQ process identifier (PID) associated with a first data unit to be transmitted on the first CG occasion based on the determined HARQ process prioritization rule and configuring transceiver circuitry to transmit the first data unit associated with the first HARQ PID using the first CG PUSCH occasion.

In a thirty first example, a processor configured to perform the method of the thirtieth example.

In a thirty second example, a user equipment (UE) comprising a transceiver configured to communicate with a network and a processor communicatively coupled to the transceiver and configured to perform the method of the thirtieth example.

In a thirty third example, a method comprising decoding, from signaling received from a network, a configured grant (CG) configuration, wherein each CG configuration comprises one or more CG Physical Uplink Shared Channel (PUSCH) occasions per CG period and a hybrid automatic repeat request (HARQ) prioritization rule, wherein the HARQ process prioritization rule is based on data availability in buffers of one or more identified logical channels (LCHs), processing a first CG PUSCH occasion of the CG configuration, wherein the processing comprises selecting a first HARQ process identifier (PID) associated with a first data unit to be transmitted on the first CG occasion based on the HARQ process prioritization rule and configuring transceiver circuitry to transmit the first data unit associated with the first HARQ PID using the first CG PUSCH occasion.

In a thirty fourth example, the method of the thirty third example, wherein, when data is available in a buffer of at least one of the identified LCHs, the processing circuitry is configured to prioritize a new transmission that includes the data from the buffer of the at least one of the identified LCHs.

In a thirty fifth example, the method of the thirty third example, wherein, when data is not available in a buffer of at least one of the identified LCHs, the processing circuitry is configured to prioritize retransmissions or Medium Access Control (MAC) Protocol Data Units (PDU) based on LCH priority.

In a thirty sixth example, the method of the thirty third example, wherein the processing circuitry is configured to prioritize new transmissions over retransmissions when data is available in a buffer of any LCHs that are allowed to use a CG PUSCH occasion of a CG configuration.

In a thirty seventh example, a processor configured to perform any of the methods of the thirty third through thirty sixth examples.

In a thirty eighth example, a user equipment (UE) comprising a transceiver configured to communicate with a network and a processor communicatively coupled to the transceiver and configured to perform any of the methods of the thirty third through thirty sixth examples.

In a thirty ninth example, a method comprising decoding, from signaling received from a network, a configured grant (CG) configuration, wherein each CG configuration comprises one or more CG Physical Uplink Shared Channel (PUSCH) occasions per CG period and a hybrid automatic repeat request (HARQ) prioritization rule, wherein the HARQ process prioritization rule is based on data delay information for the UE, processing a first CG PUSCH occasion of the CG configuration, wherein the processing comprises selecting a first HARQ process identifier (PID) associated with a first data unit to be transmitted on the first CG occasion based on the HARQ process prioritization rule and configuring transceiver circuitry to transmit the first data unit associated with the first HARQ PID using the first CG PUSCH occasion.

In a fortieth example, the method of the thirty ninth example, wherein, in response to the prioritization rule, the method further comprises determining a first remaining time to a delivery deadline for data associated with a new transmission and a second remaining time to a delivery deadline for data associated with a retransmission and prioritizing data associated with the lesser of the first remaining time or the second remaining time.

In a forty first example, the method of the fortieth example, wherein the data associated with the new transmission is associated with a Medium Access Control (MAC) Protocol Data Unit (PDU) comprising data from multiple LCHs, wherein the first remaining time is determined as a lowest remaining time for the multiple LCHs, a highest remaining time for the multiple LCHs, or an average remaining for the multiple LCHs.

In a forty second example, the method of the thirty ninth example, wherein, in response to the prioritization rule, the method further comprises comparing a remaining time to a delivery deadline for data associated with a new transmission to a threshold and prioritizing the new transmission when the remaining time satisfies the threshold, otherwise prioritize a retransmission.

In a forty third example, the method of the thirty ninth example, wherein, in response to the prioritization rule, the method further comprises comparing a remaining time to a delivery deadline for data associated with a retransmission to a threshold and prioritizing the retransmission when the remaining time satisfies the threshold, otherwise prioritize a new transmission.

In a forty fourth example, the method of the thirty ninth example, wherein the data delay information is associated to an identified LCH, an identified logical channel group (LC), an identified Quality of Service Flow Indicator (QFI), an identified Protocol Data Unit (PDU) session, or an identified type of PDU set.

In a forty fifth example, the method of the thirty ninth example, wherein the data delay information comprises a buffered time indicating how long data has been queueing in a buffer or a number of LCHs or MAC Service Data Units (SDUs) that are considered as urgent for a new transmission MAC PDU or a retransmission MAC PDU.

In a forty sixth example, a processor configured to perform any of the methods of the thirty ninth through forty fifth examples.

In a forty seventh example, a user equipment (UE) comprising a transceiver configured to communicate with a network and a processor communicatively coupled to the transceiver and configured to perform any of the methods of the thirty ninth through forty fifth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
decode, from signaling received from a network, a plurality of configured grant (CG) configurations, wherein each CG configuration comprises one or more CG Physical Uplink Shared Channel (PUSCH) occasions per CG period and a hybrid automatic repeat request (HARQ) prioritization rule, wherein a first HARQ process prioritization rule for a first CG configuration is different than a second HARQ process prioritization rule for a second CG configuration;
process a first CG PUSCH occasion of the first CG configuration, wherein the processing comprises selecting a first HARQ process identifier (PID) associated with a first data unit to be transmitted on the first CG occasion based on the first HARQ process prioritization rule; and
generate, for transmission to the network, the first data unit associated with the first HARQ PID using the first CG PUSCH occasion.

2. The apparatus of claim 1, wherein the processing circuitry is further configured to:
process a second CG PUSCH occasion of the second CG configuration, wherein the processing comprises selecting a second HARQ PID associated with a second data unit to be transmitted on the second CG occasion based on the second HARQ process prioritization rule; and
generate, for transmission to the network, the second data associated with the second HARQ PID using the second CG PUSCH occasion.

3. The apparatus of claim 1, wherein the processing circuitry is further configured to:
decode, from signaling received from the network, an update for the first CG configuration, wherein the update comprises a third HARQ process prioritization rule for the first CG configuration that is different from the first HARQ process prioritization rule, wherein the third HARQ process prioritization rule is to be applied when processing CG PUSCH occasions of the first CG configuration occurring after the update is received.

4. The apparatus of claim 1, wherein the first CG configuration comprises multiple CG PUSCH occasions per CG period and wherein the first HARQ process prioritization rule comprises a plurality of HARQ process prioritization rules, wherein a first one of the plurality of HARQ process prioritization rules applies to a first subset of the multiple CG PUSCH occasions and a second one of the plurality of HARQ process prioritization rules applies to a second subset of the multiple CG PUSCH occasions.

5. The apparatus of claim 1, wherein the HARQ process prioritization rule comprises prioritizing retransmissions or prioritizing Medium Access Control (MAC) Protocol Data Units (PDU) based on LCH priority.

6. The apparatus of claim 1, wherein the HARQ process prioritization rule is based on data availability in buffers of one or more identified LCHs.

7. The apparatus of claim 6, wherein, when data is available in a buffer of at least one of the identified LCHs, the processing circuitry is configured to prioritize a new transmission that includes the data from the buffer of the at least one of the identified LCHs.

8. The apparatus of claim 8, wherein, when data is not available in a buffer of at least one of the identified LCHs, the processing circuitry is configured to prioritize retransmissions or Medium Access Control (MAC) Protocol Data Units (PDU) based on LCH priority.

9. The apparatus of claim 6, wherein the processing circuitry is configured to prioritize new transmissions over retransmissions when data is available in a buffer of any LCHs that are allowed to use a CG PUSCH occasion of a CG configuration.

10. The apparatus of claim 1, wherein the HARQ process prioritization rule is based on data delay information for the UE.

11. The apparatus of claim 10, wherein, in response to the prioritization rule, the processing circuitry is configured to:
determine a first remaining time to a delivery deadline for data associated with a new transmission and a second remaining time to a delivery deadline for data associated with a retransmission; and
prioritize data associated with the lesser of the first remaining time or the second remaining time,
wherein the data associated with the new transmission is associated with a Medium Access Control (MAC) Protocol Data Unit (PDU) comprising data from multiple LCHs, wherein the first remaining time is to be determined as a lowest remaining time for the multiple LCHs, a highest remaining time for the multiple LCHs, or an average remaining for the multiple LCHs.

12. The apparatus of claim 10, wherein, in response to the prioritization rule, the processing circuitry is configured to:
compare a remaining time to a delivery deadline for data associated with a new transmission to a threshold; and
prioritize the new transmission when the remaining time satisfies the threshold, otherwise prioritize a retransmission.

13. The apparatus of claim 10, wherein, in response to the prioritization rule, the processing circuitry is configured to:
compare a remaining time to a delivery deadline for data associated with a retransmission to a threshold; and
prioritize the retransmission when the remaining time satisfies the threshold, otherwise prioritize a new transmission.

14. The apparatus of claim 10, wherein the data delay information is associated to an identified LCH, an identified logical channel group (LC), an identified Quality of Service Flow Indicator (QFI), an identified Protocol Data Unit (PDU) session, or an identified type of PDU set.

15. The apparatus of claim 10, wherein the data delay information comprises a buffered time indicating how long data has been queueing in a buffer or a number of LCHs or MAC Service Data Units (SDUs) that are considered as urgent for a new transmission MAC PDU or a retransmission MAC PDU.

16. An apparatus comprising processing circuitry configured to:
decode, from signaling received from a network, a configured grant (CG) configuration and two or more hybrid automatic repeat request (HARQ) prioritization rules;
process a first CG Physical Uplink Shared Channel (PUSCH) occasion, wherein the processing comprises selecting a first HARQ process identifier (PID) associated with a first data unit to be transmitted in the first CG PUSCH occasion based on a first one of the two or more HARQ process prioritization rules; and
generate, for transmission to the network, the first data unit associated with the first HARQ PID using the first CG PUSCH occasion.

17. The apparatus of claim 16, wherein the processing circuitry is further configured to:
switch from the first one of the two or more HARQ process prioritization rules to a second one of the two or more HARQ process prioritization rules;
process a second CG PUSCH occasion, wherein the processing comprises selecting a second HARQ PID associated with a second data unit to be transmitted in the second CG PUSCH occasion based on the second one of the two or more HARQ process prioritization rules; and
generate, for transmission to the network, the second data unit associated with the second HARQ PID using the second CG PUSCH occasion.

18. The apparatus of claim 17, wherein (i) the first CG occasion and the second CG occasion are in a same CG period, (ii) the first CG occasion is in a first CG period and the second CG occasion is in a second CG period, (iii) multiple CG PUSCH occasions per CG period or (iv) a single CG PUSCH occasion per CG period.

19. The apparatus of claim 17, wherein the switch is based on one of (i) a fixed switching pattern (ii) switching information provided by the network in the CG configuration or (iii) based on an occurrence of a predetermined event.

20. An apparatus comprising processing circuitry configured to:
decode, from signaling received from a network, a plurality of configured grant (CG) configurations, wherein each CG configuration comprises one or more CG Physical Uplink Shared Channel (PUSCH) occasions per CG period;
determine a hybrid automatic repeat request (HARQ) prioritization rule that is to be applied to each of the CG configurations based on at least a characteristic of each of the CG configurations;
process a first CG PUSCH occasion of a first CG configuration, wherein the processing comprises selecting a first HARQ process identifier (PID) associated with a first data unit to be transmitted on the first CG occasion based on the determined HARQ process prioritization rule; and
generate, for transmission to the network, the first data unit associated with the first HARQ PID using the first CG PUSCH occasion.
